(19) United States
(12) Patent Application Publication
(10) Pub. No.: US 2006/0178496 A1
(43) Pub. Date: Aug. 10, 2006

(54) Silica aerogels with high-temperature hydrophobation synthesized by using co-precursor solutions

(75) Inventors: Kun-Cheng Lin, Hsinchu (TW); Chia-Jen Liu, Hsinchu (TW); Jing-Lyang Jeng, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/050,848

(22) Filed: Feb. 7, 2005

(51) Int. Cl. C08G 77/04

(52) U.S. Cl. 528/39; 528/43; 524/858

(57) ABSTRACT

The present invention discloses a high-temperature stable, low density and transparent silica aerogel prepared by carrying out a sol-gel process of a mixture containing a main precursor of inorganic siloxane and a high-temperature stable precursor to form a wet gel, wherein the high-temperature stable precursor and the main precursor undergo covalent-bond crosslinking; aging and supercritical drying the wet gel to form a low density, tough, hydrophobic silica aerogel of a porous network structure. The hydrophobation of the aerogel of the present invention prevails after several times of heating at 500° C., and the structure of the aerogel will not collapse caused by moisture.

### FIELD OF THE INVENTION

The present invention relates to a method for preparing a hydrophobic silica aerogel, and particularly to a method for preparing a high-temperature stable, low density, transparent, and hydrophobic silica aerogel. Such a hydrophobic silica aerogel can be used as a thermal insulation material.

### BACKGROUND OF THE INVENTION

In a conventional sol-gel method for producing glass or ceramics, siloxane is the most commonly used precursor. The chemical formula of siloxane can be represented by Si(OR)₄, wherein R represents alkyl. The sol-gel process mainly comprises a hydrolysis step and a condensation step:

1. Hydrolysis Reaction:

An OR group in the siloxane reacts with water. Most of this type of substance is easily hydrolyzed to form a hydroxide. An OH group in the water molecule substitutes an OR group in the siloxane, and an alcohol is released. After being mixed with water, a precursor Si(OR)₄ undergoes a hydrolysis reaction under the presence of an acid or alkaline catalyst, wherein the chemical reaction mechanism thereof is shown in the following:

$$\begin{matrix}{( R O ) }_{3} Si O R + 4 {H}_{2} O ⇔ H O {Si ( O R )}_{3} + R O H \\ ⇒ {Si ( O H )}_{4} + 4 R O H\end{matrix} \qquad ( 1 )$$

For example, when Si(OC₂H₅)₄ (tetraethylorthosilicate, or tetraethoxysilane, abbreviated as TEOS) is used as a precursor:
Si(OC₂H₅)₄+4H₂O→Si(OH)₄+4C₂H₅OH (2)

The hydroxyl-containing siloxane is likely to continue to react with the alkoxyl group or hydroxyl group in the other alkoxide to form a bridging oxygen and release alcohol or moisture. For example, as shown in the following reaction, a wet gel with a silica network structure is formed.

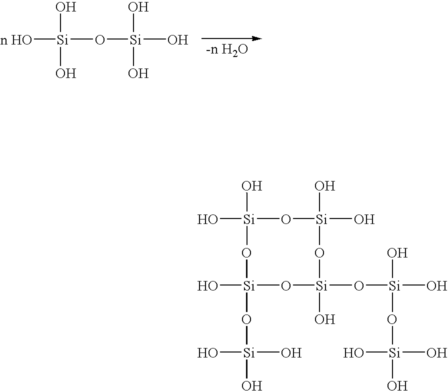

Next, water is used to wash off the salt contained in the wet gel, then alcohol is used to substitute out water, and finally alcohol is evaporated under a high pressure. Alternatively, the wet gel is dried by directly using a supercritical fluid to form an aerogel, while avoiding the problem of collapse or rupture of the gel structure caused by an excessive surface tension on the liquid-gas interface during the evaporation process of water or solvent.

Silica aerogel is a light, low density, high surface area mesoporous material, which is normally applied on a temperature sensitive product for improving the energy efficiency of the product due to the low thermal conductivity coefficient of the aerogel. Aerogel will deteriorate over time due to the fact that Si atoms receive an OH-nucleophilic attack in a damp environment, which leads to a breakage of the Si—O—Si bonding and causes a structural collapse. Meanwhile, from the point of a long life, an aerogel needs to provide water-repellent or hydrophobic properties to improve the damping phenomena. On the other hand, the chemical composition of aerogel is silica, which is very brittle like glass.

In 1992, Smith, Brinker, and Deshpande (Journal of Non-Crystalline Solids 142, 3, 197-207, 1992) firstly use a water/alcohol substitution; and silylating a ˜SiOH group, for example, the addition of chlorotrimethylsilane, which causes the surface reaction activity to drop, thereby achieving a demand on hydrophobation. Such a method can withstand a 28% reversible shrinkage of the original volume. In 1995, Yokogawa et al. (Journal of Non-Crystalline Solids 186, 23-29, 1995) observe a similar result; however, the hydrophobic aerogel developed by them is modified by a wet gel surface induced derivation method. An aerogel synthesized by this method is also transparent. Hexamethyldisilazane is used as a hydrophobation agent by them. The defect of a wet gel surface induced derivation method includes that the production process thereof is very time-consuming. In 2003, A. Venkateswara Rao (Journal of Sol-Gel Science and Technology 27, 103-109, 2003) proposes another method for synthesizing a hydrophobic aerogel, which comprises carrying out a hydrolysis condensation by adding trimethylethoxysilane (TMES) as a co-precursor to synthesize a —Si(CH₃)₃—containing wet gel, which is then subjected to a condensation to form a hydrophobic aerogel. One major advantage of the use of a co-precursor over the surface induced derivation method includes that an aerogel produced therefrom has a wider light transmittance range (93%) and a wider contact angle range (90° to 130°).

British Patent 682574 (1952) discloses a hydrophobic silica particle, which is produced by reacting a fluorinated silane modifying agent containing one or two C1-C4 alkyl groups and silica gel.

The hydrophobic property of an ordinary silica aerogel can be retained only upto about 240° C. Exceeding said temperatur, the aerogel will turn from hydrophobic into hydrophilic. This is because the organic film formed from the modifier on the surface of the aerogel will decompose to gaseous form under heat, and the ˜SiOH group left on the surface of the silica aerogel is hydrophilic. The hydrophobic property of an ordinary silylated hydrophobic silica aerogel can not be maintained above 500° C. This might be caused by an insufficient strength of bonding between the co-precursor and the silica precursor, and a non-uniform distribution of the co-precursor over the whole silica aerogel.

### SUMMARY OF THE INVENTION

The present invention discloses a high-temperature stable, low density, and transparent silica aerogel prepared by carrying out a sol-gel process of a mixture containing a main precursor of inorganic siloxane and a high-temperature stable precursor to form a wet gel, wherein the high-temperature stable precursor and the main precursor undergo covalent-bond crosslinking; aging and supercritical drying the wet gel to form a low density, tough, hydrophobic silica aerogel of a porous network structure. Meanwhile, the hydrophobation of the aerogel of the present invention prevails after several times of heating at 500° C., and the structure of the aerogel will not collapse caused by moisture.

The present invention uses tetramethoxysilane (TMOS) as a precursor, phenyltriethoxysilane (PTES) or a derivative thereof as a high-temperature stable co-precursor, wherein the mole ratio of PTES to TMOS is 0.1 to 2.35. A sol-gel reaction according to the present invention uses methanol as a co-solvent for the precursor and water, and uses ammonia water (NH₄OH) as a catalyst. The wet gel obtained by the sol-gel reaction is then subjected to a supercritical drying to synthesize a high-temperature stable, low density, and transparent silica aerogel. A transparent and low density silica aerogel obtained in a preferred embodiment of the present invention uses TMOS:methanol:H₂O:NH₄OH=1:11:5:3.7×10⁻³ (mole ratio).

### DETAILED DESCRIPTION OF THE INVENTION

A method for preparing a transparent and low density silica aerogel according to one of the a preferred embodiments of the present invention comprises:
1. performing a hydrolysis and condensation reactions of tetramethoxysilane (TMOS) (main precursor), a high-temperature stable co-precursor, phenyltriethoxysilane (PTES) and water in methanol and in the presence of ammonium hydroxide (catalyst), wherein a mole ratio of. TMOS:methanol:H₂O:NH₄OH=1:X:Y:Z is kept within a specified range with X of 10-15; Y of 3-6; and Z of 2×10⁻³-6×10⁻³, and PMES/TMOS mole ratio is smaller than 2.35 in order to obtain a transparent and low density silica aerogel;
2. mixing the sol-gel mixture homogeneously to obtain a sol;
3. performing a gelation reaction on the sol at room temperature for 3 hours;
4. aging the resulting wet gel at room temperature for two to ten days; and
5. performing an ethanol supercritical drying on the aged semi-product at a temperature of 243° C. and a pressure of 63 bars.

### EXAMPLE

(a) Dissolving 1 mole of tetramethoxysilane (TMOS) and 0.1 mole of phenyltriethoxysilane (PTES) in 11 moles of methanol; mixing 3.7×10⁻³ mole of ammonium hydroxide with 5 moles of deionized water; mixing the above two solutions in a reaction tank at 150 RPM for 20 minutes;
(b) allowing the resulting mixture in the reaction tank undergoing a gelation reaction without stirring at room temperature for 3 hours, during which the reaction tank was isolated from the ambient air by covering with an air-nonpermeable film;
(c) evaporating solvent from the reaction mixture and aging the product in air at room temperature for 3 days to form a wet gel;
(d) placing the wet gel in an air-tight container and introducing a supercritical fluid of ethanol into the container, and maintaining said container at a temperature of 243° C. and a pressure of 63 bars; and
(e) terminating the introduction of ethanol after 1 hour of introduction; gradually reducing the pressure of the container (0.3 bars/minute) to atmospheric pressure; gradually reducing the temperature to room temperature; and removing the resulting silica aerogel from said container.

A silica aerogel obtained from this example has a density of 5 g/cm³, a BET specific surface area of 900 m²/g, a porosity volume of 0.2 cm³/g, an average void size of 10 Angstrom (Å), and a thermal conductivity coefficient of 0.08 W/m-k.

Said aerogel product was heated in a vacuum furnace at 500° C. for 300 minutes, and a contact-angle-measuring device was used for measuring the water contact angle of the aerogel. The test results indicate that the water contact angles of the aerogel are all exceeding 130 degrees after several times of said heat treatment, and the structure thereof does not collapse due to dampness.

1. A method for preparing a hydrophobic silica aerogel, which comprises the following steps:
i) preparing a wet gel comprising performing a hydrolysis and condensation reactions in a mixture comprising tetramethoxysilane (TMOS) as a main precursor, phenyltriethoxysilane or its derivative as a co-precursor, methanol, water, and alkaline, thereby forming a wet gel, wherein a mole ratio of methanol to TMOS is 10-15, a mole ratio of water to TMOS is 3-6, a mole ratio of the alkaline to TMOS is 2×10⁻³-6×10⁻³, and a mole ratio of the co-precursor to TMOS is 0.1-2.35; and
ii) contacting said wet gel with a supercritical fluid to remove the water, alcohol and alkaline contained in the wet gel, so that a hydrophobic silica aerogel is formed.

2. The method as claimed in claim 1, wherein the co-precursor in step i) is phenyltriethoxysilane.

3. The method as claimed in claim 2, wherein the mole ratio of methanol to TMOS is 5, the mole ratio of water to TMOS is 7, the mole ratio of the alkaline to TMOS is 3.7×10⁻³, and the mole ratio of the co-precursor to TMOS is 0.1 in step i).

4. The method as claimed in claim 3, wherein said alkaline is ammonium hydroxide.
